(19) United States
(12) Patent Application Publication
(10) Pub. No.: US 2026/0364664 A1
(43) Pub. Date: Nov. 19, 2026

(54) COIL FOR DEFORMING METAL PARTS BY MAGNETIC PULSE, METHODS FOR PRODUCING AND RECONDITIONING SUCH A COIL

(71) Applicant: ADM28 FRANCE, TOULOUSE (FR)

(72) Inventors: Pierre THOUET, MONTBERON (FR); Thomas RIVAULT, TOULOUSE (FR); Gilles AVRILLAUD, PINSAGUEL (FR); Jean-Paul CUQ LELANDAIS, CUGNAUX (FR); Christophe VERDY, EVETTE-SALBERT (FR)

(21) Appl. No.: 19/133,867

(22) PCT Filed: Dec. 14, 2023
(86) PCT No.: PCT/EP2023/085935

§ 371 Date: May 29, 2025

(30) Foreign Application Priority Data
Dec. 16, 2022 (FR) 2213530

(51) Int. Cl. B21D 26/14; H01F 5/02; H01F 41/04

(52) U.S. Cl. CPC B21D 26/14; H01F 5/02; H01F 41/04

(57) ABSTRACT

A coil to deform a metal part by a magnetic pulse. The coil includes a body having a first surface positioned to face the metal part to be deformed. The coil includes at the first surface a reinforcement. The reinforcement consists of a metal material deposited by a cold thermal spraying.

### FIELD OF THE INVENTION

The present invention falls within the field of forming, welding or crimping metal parts. More particularly, it falls within the field of forming, welding or crimping metal parts by magnetic pulse, commonly referred to as Magnetic Pulse Forming (MPF), Magnetic Pulse Welding (MPW) or Magnetic Pulse Crimping (MPC). The present invention relates to an enhanced coil making it possible to extend its lifetime. The present invention also relates to a method for producing said coil and a method for reconditioning said coil.

### PRIOR ART

Deformation of metal parts by magnetic pulse is carried out under the action of electromagnetic forces generated by a coil. This deformation makes it possible to carry out either forming operations to shape a metal part according to the shape of a die, or welding or crimping operations to assemble two parts together permanently.

Conventionally, a device for deforming metal parts by magnetic pulse comprises several capacitors, forming an electrical energy storage unit, and a switch, connected to a coil to create a brief and intense magnetic field. The electrical energy storage unit is used to store a large quantity of electrical energy. When the switch is closed, the electrical energy stored in the electrical storage unit is discharged very rapidly in the coil, in the form of a variable current of very high intensity, in a very short time, thus creating an intense magnetic field. For example, some devices can reach a current of a few hundred thousand amperes in a few microseconds.

The current generates a variable and intense magnetic field between the coil and the metal part to be deformed, previously placed in the vicinity, and induces eddy currents in this part. These eddy currents, associated with the surrounding magnetic field, develop Laplace forces in the metal part to be deformed, which cause a strong acceleration of the part towards either a die or another part.

According to the intensity of the generated current, the collision angle and the collision speed in particular, a part is either formed, welded or crimped to another part.

However, magnetic pulse deformation methods have the drawback of requiring very high intensities to form a part or weld/crimp it to another part, which involves the use of a considerable quantity of electrical energy. The use of such intensities also generates locally temperatures and substantial mechanical stresses in the coil, which can weaken it, shortening its lifetime, and leading to irreparable damage to the coil, particularly at a zone, referred to as the “active part”. Active part means a zone of the coil where the current, delivered by the electrical energy storage unit, is concentrated and flows, to create the magnetic field.

Damage on the coil, typically in the form of cracks and/or crazing, degrades the performance of magnetic pulse deformation methods.

For example, for a coil conventionally made of a copper alloy material, such as CuCr, the lifetime of the coil is estimated at 25,000 discharges. After 25,000 discharges, crazing at the active part on the coil degrades the performance of the magnetic pulse deformation method critically, and impacts the forming, welding or crimping quality too substantially. For a coil conventionally made of a steel material such as 40CMD8, the lifetime of the coil is estimated at 15,000 discharges.

However, these lifetimes prove to be very limiting when the coils are used in industry, on production lines for example. The coils need to be changed regularly, which gives rise to a production line shutdown and incurs non-negligible costs.

There is therefore a real need to extend the lifetime of coils used in methods for deforming metal parts by magnetic pulse.

### DISCLOSURE OF THE INVENTION

The aim of the present invention, which results from work carried out in collaboration with UTBM (Université de Technologie de Belfort Montbéliard), is that of overcoming the aforementioned drawbacks.

The aim of the present invention is particularly that of providing an effective solution for extending the lifetime of a coil for deforming a metal part by magnetic pulse (for example, by magnetic pulse forming and/or magnetic pulse welding and/or magnetic pulse crimping).

Thus, the invention relates to a coil for deforming a metal part by magnetic pulse, comprising a body which has a first surface intended to be positioned facing the metal part to be deformed. At said first surface, the coil comprises a reinforcement, and said reinforcement consists of a metal material deposited by cold thermal spraying.

The reinforcement thus forms a coating on the first surface of the coil body. However, adding a coating on the first surface of the coil body goes against a consistent preconception in the prior art that adding a coating on this first surface is not viable. Indeed, on one hand, it is difficult to retain an electrical continuity at the interface between the coil body and the coating. An electrical discontinuity will influence the creation of the magnetic field and may degrade the quality of the end product by the magnetic pulse deformation method. On the other, adding a coating on the first surface may create potential cavities at the interface between the coil body and the coating. There is a significant risk of an electric arc forming in these cavities and causing degradation of the coil.

The present invention mitigates the aforementioned drawbacks and overcomes the technical preconception by depositing a metal material by the cold thermal spraying method. The cold thermal spraying method is generally known as cold spray.

The cold thermal spraying method involves spraying particles onto a surface. More specifically, the cold thermal spraying method consists in spraying metal material particles at very high speed, by a gas under high pressure, onto the first surface of the body. The impact force ensures the cold welding of this metal material on said first surface of the body, and the cohesion of the particles to form a dense reinforcement therein. The metal material particles are welded, firstly on the first surface of the coil body, and then on themselves. The cold thermal spraying method advantageously allows a good cohesion with the first surface of the body subjected to spraying as well as a low porosity of the deposited metal material. Thus, the electrical continuity is retained at the interface between the coil body and the reinforcement, and electric arc formation at this interface is reduced. Furthermore, the low porosity of the deposited metal material also reduces electric arc formation in the reinforcement.

Thus, during the use of the coil according to the invention in a method for deforming the metal part by magnetic pulse, the current flowing in said coil is concentrated in an active part which is then located at the reinforcement, whereas initially, without the reinforcement, the current is concentrated on the first surface of the body.

Such a reinforcement thus makes it possible to increase the lifetime of the coil significantly.

Preferably, the material used to form the reinforcement has superior mechanical and thermal resistance features to the material of the body, in order to enhance the lifetime of the coil even further.

According to preferred embodiments, the invention furthermore fulfils the following features, implemented separately or according to any of their technically feasible combinations.

According to preferred embodiments, the coil comprises a magnetic field concentrator at the first surface of the body. The magnetic field concentrator comprises a first surface intended to be positioned facing the metal part to be deformed. The coil comprises, at the first surface of the magnetic field concentrator, the reinforcement consisting of a metal material deposited by cold thermal spraying. In the case of the use of the magnetic field concentrator, the reinforcement is now formed on the first surface of the magnetic field concentrator and no longer on the first surface of the coil body. During the use of the coil in a method for deforming the metal part by magnetic pulse, the current flowing in the coil is concentrated in an active part which is then located at the reinforcement, whereas initially, without the reinforcement, the current is concentrated on the first surface of the magnetic field concentrator.

The invention also relates to a method for producing a coil in at least one of its embodiments. The production method comprises the successive steps of:
depositing, on the first surface of the coil body, or of the field concentrator where present, a metal material by cold thermal spraying to form the reinforcement,
tempering heat treatment of the body, or of the magnetic field concentrator, and of the reinforcement,
finish-machining the reinforcement.

According to preferred implementations, the invention furthermore fulfils the following features, implemented separately or according to any of their technically feasible combinations.

According to preferred implementations, the production method comprises, prior to the deposition step, a step of removing, from an initial surface of the coil body, or of the magnetic field concentrator where present, a layer of material forming said body, or said field concentrator, up to the first surface of the coil body, or of the magnetic field concentrator.

The invention also relates to a method for reconditioning a coil in at least one of its embodiments, when it is worn. The reconditioning method comprises the successive steps of:
removing the reinforcement over its entire thickness,
removing, from the first surface of the body, or of the magnetic field concentrator where present, a layer of material forming said body or said magnetic field concentrator, of a predefined thickness, up to a second surface of the body, or of the magnetic field concentrator,
depositing at the second surface of the body or of the field concentrator, a metal material by cold thermal spraying to form a new reinforcement, over a predefined thickness, corresponding at least to the sum of the thickness of the previous reinforcement removed and the thickness of the layer of material removed,
tempering heat treatment of the body, or the magnetic field concentrator, and the new reinforcement,
finish-machining the new reinforcement.

The step of removing the reinforcement advantageously makes it possible to remove any trace of cracks and/or crazing which could impact the future performance of the reconditioned coil.

The step of removing a layer of material forming the coil body, or the magnetic field concentrator, advantageously makes it possible to remove any trace of the deformation of the first surface by the spraying of the metal material particles. A new clean surface for receiving a new deposition of metal material by cold thermal spraying is thus guaranteed.

Following the finish-machining, the new reinforcement thus has a thickness equal to the sum of the thickness of the previous reinforcement removed and the thickness of the layer of material removed.

According to preferred implementations, the invention furthermore fulfils the following features, implemented separately or according to any of their technically feasible combinations.

According to preferred implementations, each time the reinforcement of the coil is worn, the steps of removing the reinforcement over its entire thickness and removing an additional layer of material from the coil body, or from the magnetic field concentrator, are repeated successively, followed by the step of depositing a metal material by a cold thermal spraying method until a new reinforcement is obtained, said new reinforcement having, after each reconditioning, a thickness corresponding to the thickness of the previous reinforcement, increased by the thickness of the layer of material of the coil body, or of the magnetic field concentrator removed.

Such a reconditioning method makes it possible to renew the coil at a significantly reduced cost compared to a total replacement of the coil or the magnetic field concentrator.

According to preferred implementations, the steps of the reconditioning method are repeated up to a predefined maximum thickness of the reinforcement. Indeed, the cold thermal spraying method generating high stresses in the metal material particles, if the reinforcement has an excessive thickness, detachments of said reinforcement could appear.

This predetermined maximum thickness is dependent particularly on the material of the metal coating and the material of the coil body or the magnetic field concentrator.

### PRESENTATION OF THE DRAWINGS

The invention will be better understood upon reading the following description, given as an example that is in no way limiting, and made while referring to the drawings which show:

FIG. 1 schematically represents a perspective view of an annular type coil according to the invention,

FIG. 2 schematically represents a front view of the annular coil of FIG. 1,

FIG. 3 represents a cross-section of the annular coil of FIG. 2 along the line AA, wherein two metal parts to be welded are positioned,

FIG. 4 schematically represents a perspective view of an annular coil comprising a magnetic field concentrator according to another embodiment of the invention,

FIG. 5 schematically represents a front view of the annular coil of FIG. 4,

FIG. 6 represents a cross-section of the annular coil of FIG. 5 along the line AA, wherein a metal part and a die are positioned,

FIG. 7 represents the steps of a method for producing an annular coil according to FIG. 4,

FIG. 8 represents the steps of a method for reconditioning an annular coil according to FIG. 4, in the worn state, and

FIG. 9 schematically represents a perspective view of a flat type coil according to the invention.

### DETAILED DESCRIPTION OF THE INVENTION

The different figures as well as the elements of the same figure are not necessarily represented at the same scale. In all of the figures, identical elements bear the same reference numeral.

The terminology used in the present description should in no way be interpreted as limiting or restrictive, merely because it is used in conjunction with a detailed description of certain embodiments of the invention.

The present invention relates to a coil for deforming metal parts by magnetic pulse, such as by magnetic pulse forming, by magnetic pulse welding or by magnetic pulse crimping.

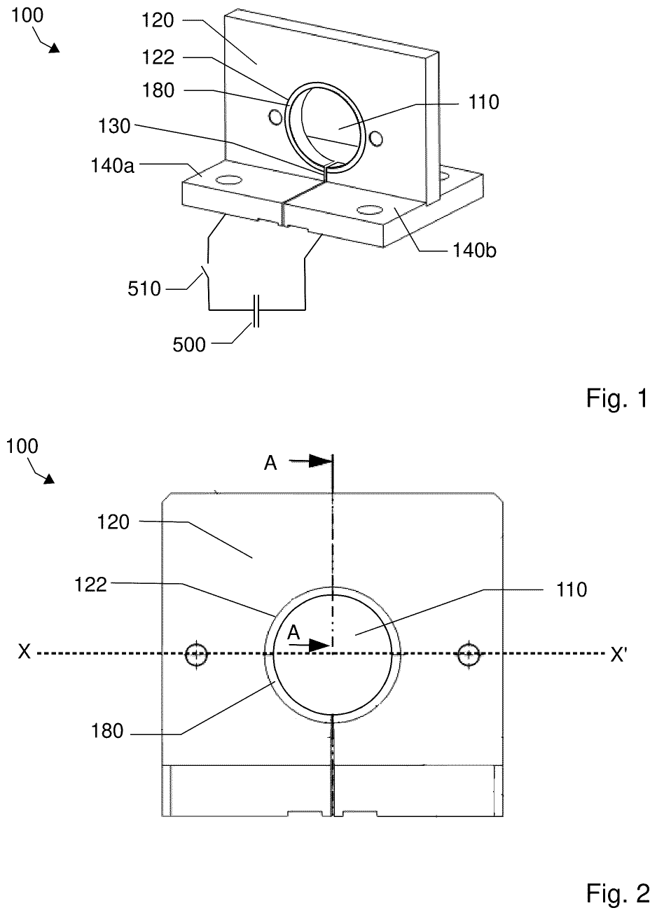

The coil 100 is an integral part of a device further comprising a storage unit 500 and one or more switches 510, as illustrated in FIG. 1.

The storage unit 500 is connected conventionally to the coil 100 and to the switch(es) 510. The storage unit 500 is configured to store a high energy, for example in the order of some tens of kilojoules (kJ). The storage unit 500 is for example a capacitor bank.

A very rapid discharge of this electrical energy in the coil 100, in the form of a variable current of very high intensity, makes it possible to create an intense magnetic field.

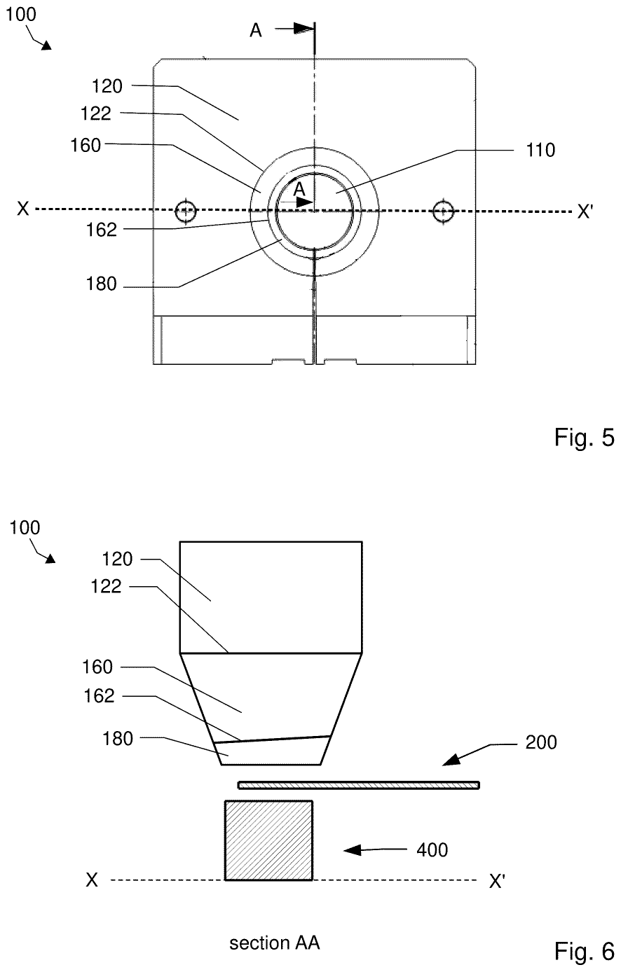

Hereinafter in the text, as illustrated in FIGS. 1 to 8, the invention will be described, in a non-limiting manner, in a coil configuration where the coil is of the annular coil type. This coil configuration is particularly adapted for carrying out deformation operations on tubular parts.

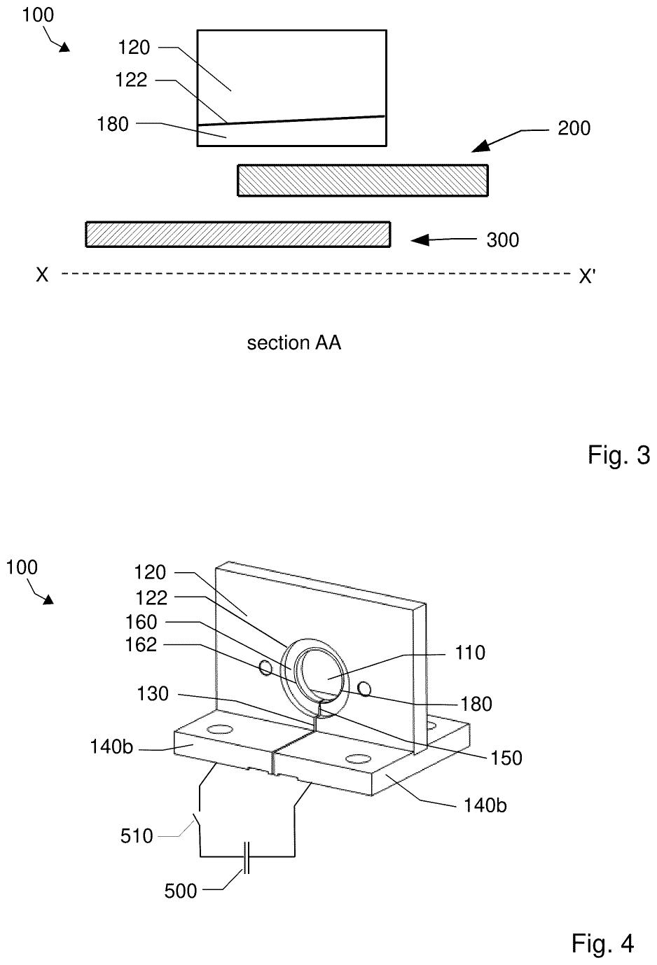

The coil 100 comprises a body 120. A tubular opening 110 is produced in said body. Said opening is sized and configured to receive:
either two tubular parts, referred to as first part 200 and second part 300, disposed one in the other with a view to their welding or crimping, as illustrated in FIG. 3, the first part 200 being arranged around the second part 300,
or a die 400 and a tubular part, referred to as first part 200, disposed around the die, with a view to forming said first part, as illustrated in FIG. 6.

The body 120 of the coil 100 has a peripheral surface, referred to as first surface 122, delimiting the opening 110. Thus, the first surface 122 of the body 120 is intended to be positioned facing the part to be deformed, therefore the first part 200, received in the opening 110.

The body 120 of the coil 100 further comprises a narrow slot 130 extending from the opening 110. The body can comprise two symmetrically opposite contact plates 140a, 140b, extending on either side of the slot 130. The contact plates 140a, 140b are connected to the energy storage unit 500 and to the switch(es) 510.

The coil body 120 is made of a material having specific properties in terms, on one hand, of electrical conductivity to circulate therein a current of very high intensity, of the order of a few hundred thousand Amperes and, on the other, of mechanical resistance so as not to deform plastically during the magnetic pulse forming, magnetic pulse welding or magnetic pulse crimping method.

In a preferred embodiment, the material of the coil body 120 is made of steel, of the 40CMD8 type, of copper, of the Cu ½ hard or ¾ hard type, or of a copper alloy, of the CuCr type.

The coil is therefore configured so that a high-intensity current can flow therein and produce a magnetic field.

The coil 100 is also configured so that the current density in a zone of the coil is sufficient to satisfy the desired deformation conditions. This zone is referred to as active part.

In the case of a conventional annular coil of the prior art, the current is concentrated in the active part, on a layer delimited by the first surface 122 and of thickness corresponding to the skin thickness. The current generates a concentrated magnetic field between the active part of the coil and the first part 200.

In the non-limiting example of a coil 100 made of steel, the skin thickness is of the order of a few millimetres for a frequency of some tens of kHz.

In an alternative embodiment of the coil, illustrated in FIGS. 4 to 6, the coil 100 can comprise, at the first surface 122 of the body, a magnetic field concentrator, referred to as concentrator 160. Said concentrator is an annular part intended to be disposed in the opening 110 of the body 120 of the coil and which makes it possible to concentrate the magnetic field further in the opening 110 of the coil body 120. The concentrator 160 has an opening, also tubular, sized and intended to receive either the first and second parts 200, 300, or the first part 200 and the die 400. The concentrator 160 has a peripheral surface, referred to as first surface 162, delimiting the opening of the concentrator 160. The first surface 162 of the concentrator 160 is thus intended to be positioned facing the part to be deformed, therefore the first part 200, received in the opening of the concentrator 160.

The concentrator 160 further comprises a narrow slot 150 extending from the opening of said concentrator. The slot 150 is aligned with the slot 130 of the body 120 of the coil 100.

In a preferred embodiment, the material of the concentrator 160 is made of steel, of the 40CMD8 type, or of copper alloy, of the CuCr type. Preferably, the material of the concentrator 160 is identical to the material of the coil body 120.

In the case of this alternative embodiment of the coil 100, the current is concentrated in the active part which is then located at the first surface 162 of the concentrator 160. The current is concentrated, in the active part, on a layer delimited by the first surface 162 of the concentrator 160 and of thickness corresponding to the skin thickness. The current generates, between the active part of the concentrator and the first part 200, an even more concentrated magnetic field than the magnetic field created between the active part of the coil and the first part 200, in the absence of a concentrator.

According to the invention, the coil 100 advantageously comprises, at the first surface 122 of the body 120, or at the first surface 162 of the concentrator 160 when the coil 100 comprises a concentrator 160, a reinforcement 180, as illustrated in FIGS. 1 to 3 and 4 to 6 respectively.

The reinforcement 180 has a first surface 181 intended to be facing the part to be deformed, therefore the first part 200.

This reinforcement 180 results from a deposition of metal material carried out by a cold thermal spraying method.

The cold thermal spraying method is a conventional metallisation method. Metal material particles are sprayed at very high speed, by a gas under high pressure, onto the first surface 122 of the body 120 (or onto the first surface 162 of the concentrator 160 when the coil 100 comprises a concentrator 160). The spraying pressure and speed of the metal material particles cause a plastic deformation of the sprayed metal material upon its contact with the first surface 122 (or 162) to be coated, the impact force then carrying out cold welding of this metal material on said first surface 122 (or 162), and cohesion of the particles to form a dense reinforcement thereon. The cold thermal spraying method advantageously allows good cohesion with the first surface 122 (or 162) subjected to spraying, a low porosity of the deposited metal material, and a reduced oxidation level due to the moderate temperature to which the metal material is brought.

Furthermore, the cold thermal spraying method makes it possible to achieve thicknesses of several millimetres while retaining these qualities.

The cold thermal spraying method is advantageously implemented in the invention to obtain desired mechanical and electrical performances of the reinforcement without degrading the body 120 of the coil or the concentrator 160.

The material used to form the reinforcement 180 advantageously has specific properties, in particular in terms, on one hand, of electrical conductivity to circulate therein a current of very high intensity, for example of the order of a few hundred thousand Amperes, and on the other, of mechanical resistance to plastic deformation and to high temperatures (i.e. a high melting point) so as not to melt during the magnetic pulse forming, magnetic pulse welding or magnetic pulse crimping method.

Preferably, the material used to form the reinforcement 180 is different from the material forming the body 120 and/or the concentrator 160. Preferably, the material used to form the reinforcement 180 has superior mechanical and thermal strength features to the material of the body 120 or the concentrator 160, to reinforce the coil 100 and enhance the lifetime of the coil 100.

In preferred exemplary embodiments, when the material of the coil body, or of the concentrator 160, is made of copper alloy, such as CuCr, the material used to form the reinforcement 180 is made of silver copper alloy CuAg.

Thus, in the coil 100 according to the invention, the current is concentrated in the active part which is then located at the reinforcement 180.

The current is concentrated on a layer delimited by the first surface 181 of the reinforcement and of thickness corresponding to the skin thickness. In the non-limiting example of a reinforcement made of CuAg, the skin thickness is of the order of 1 mm for a frequency of some tens of kHz.

Preferably, the reinforcement 180 has a minimum thickness hₘᵢₙ at least equal to this skin thickness. Thus, the current is then only concentrated in the reinforcement 180. During the use of the coil 100, the cracks and/or crazing are thus limited to the reinforcement 180 and are not propagated in the body 120 of the coil 100, or in the concentrator 160 when the coil comprises such a concentrator.

Preferably, the reinforcement 180 has a predefined maximum thickness hmax-This maximum thickness is defined to prevent detachments of the reinforcement 180 from the first surface 122 of the body 120 of the coil 100, or from the first surface 162 of the concentrator 160. It is indeed known that the cold thermal spraying method generates high stresses in the metal material particles, and with excessive thicknesses, detachments of the reinforcement may appear.

According to preferred embodiments, the thickness of the reinforcement 180 is between 1 mm and 20 mm.

In one exemplary embodiment, when the material of the body 120 of the coil 100, or of the concentrator 160, is made of CuCr and the material of the reinforcement 180 is made of CuAg, the minimum thickness hmin of the reinforcement 180 is of the order of 5 mm and the maximum thickness hmax of the reinforcement 180 is of the order of 9 mm.

Uniaxial tensile tests were also carried out on samples with different substrates (steel, CuCr, etc.) and different particles of metal material (CuAg, CuNiCoSi, etc.) to evaluate adherence strength. Traction was evaluated at the particle/substrate interface. Indeed, in use, during a discharge, Laplace forces will deform the metal part to be deformed, as described in the prior art. By action/reaction, similar forces will be created in the body 120 of the coil 100 (or in the concentrator 160), which will generate stresses at the first surface 122 (or 162). The tests showed that the CuCr/CuAg pair has a tensile strength of the order of 190 MPa, which is sufficient to withstand repeated discharges during the use of the coil 100.

Such a reinforcement 180 thus makes it possible to increase the lifetime of the coil 100 significantly. For example, as mentioned in the prior art, the lifetime of a conventional coil 100 (i.e. without reinforcement) made of a CuCr material, is estimated at 25,000 discharges. The lifetime of a coil 100 with a reinforcement 180 made of a CuAg material makes it possible to reach at least 100,000 discharges. The lifetime of the coil is thus multiplied four-fold.

A method for producing a coil 100 according to the invention is now described. The method will be described hereinafter, without limitation, for producing a coil 100 with a concentrator 160. The first surface 162 of the concentrator 160 will only be discussed therein. However, it is clear that, by analogy, when the coil 100 does not comprise a concentrator, the first surface mentioned will be that of the body 120 of the coil 100.

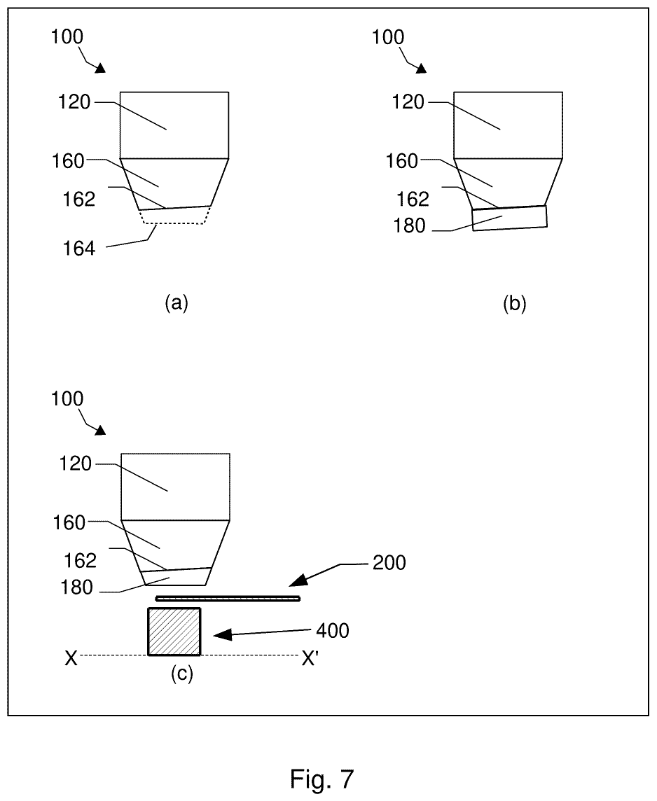

FIG. 7 illustrates the steps of the method for producing an annular coil 100 with the concentrator 160. The annular coil 100 is represented partially in a cross-section as for FIG. 6.

To produce a coil 100 according to the invention, a first step consists in depositing, on a coil without reinforcement, a metal material by a cold thermal spraying method, to form the reinforcement 180. The deposition of said metal material is carried out on the first surface 162 of the concentrator 160.

Metal material particles are sprayed at very high speed, by a gas under pressure, onto the first surface 162 of the concentrator. The particles are welded, first on the first surface 162 of the concentrator 160, then on themselves until a desired thickness is obtained for the reinforcement 180.

The metal material particles are particularly sprayed with a predefined speed and angle of impact. The spraying speed and the angle of impact advantageously make it possible to ensure good adherence of the deposition of metal material particles and limit the shear forces at the first surface 162.

In one exemplary implementation, the metal material particles are sprayed with a nozzle. The nozzle can move to form the reinforcement over the entire first surface 162.

In one embodiment, this first deposition step can be carried out according to one or more of the following operating parameters:
particles preferably between 5 and 80 μm,
gas temperature between 400 °C and 1000 °C, preferably of the order of 500°C,
gas pressure between 20 and 50 bar, preferably of the order of 30 bar,
particle spraying speed between 0.5 and 1.5 km/s,
choice of carrier gas: nitrogen or helium or a mixture of these two gases.

A person skilled in the art has the expertise to choose the operating parameters to be implemented in order to obtain a desired reinforcement thickness, preferably between the two values hₘᵢₙ and hₘₐₓ.

View (b) of FIG. 7 illustrates the coil, after this first step of deposition.

Preferably, to promote the conditions for adhering the metal material particles onto the first surface 162 of the concentrator, the method can comprise a step, prior to the first step of deposition, of removing a layer of material from the concentrator 160. The layer of material is removed from an initial surface 164 up to the first surface 162. As previously specified, the angle of impact of the metal material particles on the first surface advantageously makes it possible to ensure good adherence of the deposition of said metal material particles and limit the shear forces at the first surface 162. A person skilled in the art has the expertise to determine the required angle of impact.

The removal of the layer of material from the concentrator 160 is preferably carried out by machining.

View (a) of FIG. 7 illustrates the coil, after this prior step. The layer of material removed from the concentrator 160 is shown with a dotted line. The first surface 162 is, in the non-limiting example of view (a), inclined relative to the initial surface 164.

The method for producing a coil 100 according to the invention comprises, after the first deposition step, a second step of tempering heat treatment of the coil body, the magnetic concentrator 160 and the reinforcement 180.

This second step is conventional per se and its aim is that of giving the reinforcement 180 the desired elastic and electrical conductivity properties.

In one exemplary implementation, the coil is placed in a tempering furnace, at a predefined temperature, and for a predefined duration.

The tempering heat treatment is preferably carried out at a temperature between 200 and 400 °C, for a period between 2 and 8 hours.

The method for producing a coil 100 according to the invention then comprises a third step of finish-machining the reinforcement 180.

The finish-machining step is conventional per se and makes it possible to remove surface defects to achieve the desired final shape and dimensional values of the reinforcement 180.

View (c) of FIG. 7 illustrates the coil, after this third step.

Following this third step, the coil 100 is ready to be used for a forming, welding or crimping method.

In one implementation, the manufacturing method can comprise, before or after the third step, a step of cutting the reinforcement 180, in its thickness, at the slot 150 of the concentrator 160 such that the reinforcement 180 has a slot aligned with the slot 150 of the concentrator 160 and the slot 130 of the body 120 of the coil 100. Indeed, during the first step of depositing the metal material particles by the cold thermal spraying method, the particles cover the slot 150. If the slot is obstructed, in use, the current will not be able to flow in the coil 100 and create the magnetic field required to carry out the forming, welding or crimping methods.

In one implementation, the method can comprise upstream of the first step of deposition, a step of masking the concentrator 160 on the parts of the concentrator 160 other than the first surface 162. Such a step makes it possible to prevent other parts of the concentrator 160 receiving the metal material particles during the first step. Accordingly, after the first step, the method comprises a step of unmasking the concentrator 160.

The cutting of the reinforcement 180 is preferably carried out by electro-erosion.

Besides the fact that the coil 100 according to the invention is reinforced at the active part and thus has a substantially greater lifetime than the lifetime of a conventional coil, the coil 100 according to the invention can also be reconditioned several times with a view to being reused and extending its lifetime even more. After a first use of the coil 100 according to the invention for deforming a part by magnetic pulse forming, magnetic pulse welding or magnetic pulse crimping, and when crazing at the active part on the reinforcement degrades the performance of the magnetic pulse deformation method critically and impacts the forming, welding or crimping quality too substantially, the coil 100 can be reconditioned with a new reinforcement 180.

A method will be described hereinafter, without limitation, for reconditioning a coil 100 with a concentrator 160. The first surface 162 of the concentrator 160 will only be discussed therein. However, it is clear that, by analogy, when the coil 100 does not comprise a concentrator, the first surface mentioned will be that of the body 120 of the coil 100.

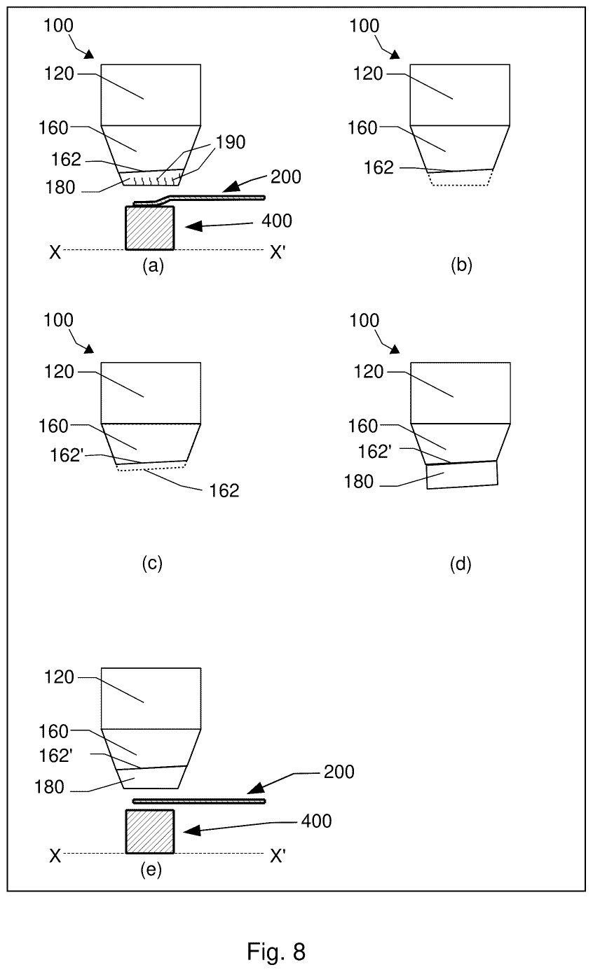

FIG. 8 illustrates the steps of the method for reconditioning an annular coil 100 with the concentrator 160. The annular coil 100 is represented partially, in a cross-section, as for FIG. 6. FIG. 8 illustrates the first reconditioning of the coil 100.

View (a) of FIG. 8 represents the coil 100 with the worn reinforcement 180. The crazing in the reinforcement 180 is schematically represented by the lines 190.

The reconditioning method comprises a first step of removing the reinforcement 180. The reinforcement is removed, over its entire thickness, up to the first surface 162 of the concentrator 160.

The removal of the reinforcement 180 is preferably carried out by machining.

View (b) of FIG. 8 illustrates the coil following this first step. The reinforcement 180 removed is shown as a dotted line.

The reconditioning method then comprises a second step of removing, from the first surface 162 of the concentrator 160, a layer of material from said concentrator.

The layer of material of the concentrator 160 is reduced by a predefined, preferably constant, thickness, up to a second surface 162′ of the concentrator 160.

Preferably, the predefined thickness of the layer of material removed is less than the thickness removed from the reinforcement.

The step of removing a layer of material forming the concentrator 160 advantageously makes it possible to remove any trace of the deformation of the first surface 162 by the spraying of the metal material particles.

The removal of the layer of material is preferably carried out by machining.

View (c) of FIG. 8 illustrates the coil following this second step. The layer of material removed from the concentrator is shown as a dotted line.

The reconditioning method then comprises a third step of depositing a metal material by the cold thermal spraying method to form a new reinforcement 180.

The metal material is deposited on the second surface 162′ of the concentrator 160.

The metal material is deposited over a predefined thickness, slightly greater than the sum of the thicknesses of the previous reinforcement removed and the layer of material removed from the concentrator.

The implementation of this third step is identical to the first step of the method for producing the coil.

View (d) of FIG. 8 illustrates the coil following this third step.

The reconditioning method then comprises a fourth step of tempering heat treatment of the body 120, the concentrator 160, and the new reinforcement 180.

The implementation of this fourth step is identical to the second step of the method for producing the coil 100. This fourth step thus makes it possible to impart the desired elastic and electrical conductivity properties to the new reinforcement 180. The reconditioning method then comprises a fifth step of finish-machining the reinforcement 180.

The implementation of this fifth step is identical to the third step of the method for producing the coil 100. This fifth step makes it possible to achieve the desired final shape and dimensional values of the new reinforcement 180.

The thickness of the new reinforcement 180 thus preferably corresponds to the sum of the thickness of the previous reinforcement removed and the thickness of the layer of material removed.

View (e) of FIG. 8 illustrates the reconditioned coil following this fifth step.

Following this fifth step, the coil with its new reinforcement can be used.

The coil with its new reinforcement 180 can again be used for a forming, welding or crimping method.

In one implementation of the reconditioning method, the reconditioning method can comprise, before or after the fifth step, a step of cutting the reinforcement, in its thickness, at the slot 150 of the concentrator 160 such that the reinforcement 180 has a slot aligned with the slot 150 of the concentrator 160 and the slot 130 of the body 120 of the coil 100.

In one implementation of the reconditioning method, the method can comprise upstream of the third step, a step of masking the concentrator 160 on the parts of the concentrator 160 other than the first surface 162.

The cutting of the reinforcement 180 is preferably carried out by electro-erosion.

Whenever the reinforcement 180 of the coil 100 is worn and the crazing at the reinforcement impacts the quality of the method for deforming a metal part by magnetic pulse too substantially, it is advantageously possible to repeat the reconditioning method several times, to extend the lifetime of the coil 100 again. Each time, the reinforcement is removed over its entire thickness and an additional layer of material from the concentrator 160 is removed. The new reinforcement thus has, each time, a thickness corresponding to the thickness of the previous reinforcement, increased by the thickness of the layer of material removed from the concentrator 160.

Preferably, the reconditioning method can be repeated until the thickness of the reinforcement 180 reaches the predefined maximum thickness hₘₐₓ.

In one exemplary implementation, the material of the concentrator 160 is made of CuCr and the material of the reinforcement 180 is made of CuAg. The minimum thickness of the reinforcement is 5 mm. The maximum thickness of the reinforcement is 9 mm. By removing only 0.2 mm of thickness of the layer of material from the concentrator at each reconditioning, the coil 100 can thus be reconditioned 20 times and therefore be used 21 times.

Accordingly, the total lifetime of said coil 100 can be up to 2,100,000discharges (21×100,000). Compared to the lifetime of the CuCr coil without reinforcement, which is in the order of 25,000 discharges, the lifetime of the CuCr coil 100 with the CuAg reinforcement 180, using the reconditioning method, is increased considerably.

The invention has been described in the preferred configuration of an annular coil. It is however possible, without departing from the scope of the invention, to adapt the invention to any other coil configuration, such as for example flat type coils.

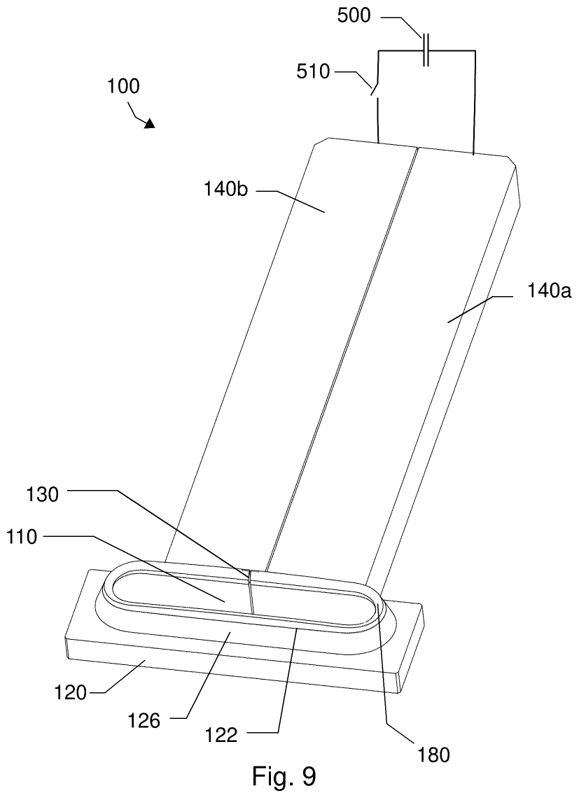

FIG. 9 illustrates an example of a flat coil. This coil is particularly adapted to carrying out operations for deforming flat parts.

The coil 100 comprises a body 120. The body 120 is in the form of a plate. A through opening 110 is produced in the body. The opening 110 is sized and configured to face the first part 200 to be deformed (not shown).

In one non-limiting embodiment, as illustrated in FIG. 9, the opening 110 has a substantially oblong-shaped cross-section.

The body 120 of the coil 100 further comprises a narrow slot 130 extending from the opening 110. The body can comprise two symmetrically opposite contact plates 140a, 140b, extending on either side of the slot 130. The contact plates 140a, 140b are connected to the energy storage unit 500 and to the switch(es) 510.

Said body has, on one face of the plate, a boss 126 arranged around the periphery of the opening 110.

The body 120 of the coil 100 comprises, at the top of the boss 126, a first surface 122, intended to be positioned facing the first part 200 to be deformed (not shown).

According to the invention, the coil 100 comprises, at the first surface 122 of the body 120, a reinforcement 180 formed by a metal material deposited by cold thermal spraying.

In this flat coil configuration, the current is also concentrated in the active part which is located in the reinforcement 180.

The method for manufacturing the flat coil and the method for reconditioning this flat coil are identical to the methods described for the annular coil.

1-7. (canceled)

8. A coil to deform a metal part by a magnetic pulse, the coil comprising:
a body comprising a first surface positioned to face the metal part to be deformed; and
a reinforcement at the first surface of the body, the reinforcement comprising a metal material deposited by a cold thermal spraying.

9. A method for producing the coil of claim 8, comprising the successive steps of:
depositing, on the first surface of the body, the metal material by the cold thermal spraying to form the reinforcement;
tempering heat treatment of the body and of the reinforcement; and
finish-machining the reinforcement.

10. The method for producing the coil of claim 9, comprising, prior to the step of depositing, a step of removing, from an initial surface of the body, a layer of material forming the body up to the first surface of the body.

11. A method for reconditioning the coil of claim 8, comprising the successive steps of:
removing the reinforcement over an entire thickness of the reinforcement;
removing, from the first surface of the body, a layer of material forming the body, of a predefined thickness, up to a second surface of the body;
depositing at the second surface of the body, the metal material by the cold thermal spraying to form a new reinforcement, over a predefined thickness corresponding at least to a sum of the entire thickness of the reinforcement removed and the predefined thickness of the layer of material removed;
tempering heat treatment of the body and the new reinforcement; and
finish-machining the new reinforcement such that the new reinforcement has a thickness equal to the sum of the entire thickness of the reinforcement removed and the predefined thickness of the layer of material removed.

12. The method of reconditioning the coil of claim 11, wherein, whenever the reinforcement of the coil is worn, further comprising a step of repeating:
removing the reinforcement over the entire thickness of the reinforcement;
removing the layer of material forming the body of the coil;
depositing the metal material by the cold thermal spraying until a subsequent new reinforcement is obtained, the subsequent new reinforcement having, after each reconditioning, a thickness corresponding to the thickness of a previous new reinforcement, increased by the thickness of the layer of material of the body of the coil removed.

13. The method of reconditioning the coil of claim 12, wherein the steps of removing the reinforcement over the entire thickness of the reinforcement, removing the layer of material forming the body of the coil, and depositing the metal material are repeated until a predefined maximum thickness of the reinforcement is reached.

14. The coil to deform a metal part by a magnetic pulse, the coil comprising:
a body comprising a first surface;
a magnetic field concentrator at the first surface of the body, the magnetic field concentrator comprising a first surface positioned to face the metal part to be deformed; and
a reinforcement at the first surface of the magnetic field concentrator, the reinforcement comprising a metal material deposited by a cold thermal spraying.

15. A method for producing a coil of claim 14, comprising the successive steps of:
depositing, on the first surface of the magnetic field concentrator, the metal material by the cold thermal spraying to form the reinforcement;
tempering heat treatment of the magnetic field concentrator and of the reinforcement; and
finish-machining the reinforcement.

16. The method for producing a coil according to claim 15, comprising, prior to the step of depositing, a step of removing, from an initial surface of the magnetic field concentrator, a layer of material forming the magnetic field concentrator up to the first surface of the magnetic field concentrator.

17. A method for reconditioning the coil of claim 14, comprising the successive steps of:
removing the reinforcement over an entire thickness of the reinforcement;
removing, from the first surface of the magnetic field concentrator, a layer of material forming the magnetic field concentrator, of a predefined thickness, up to a second surface of the magnetic field concentrator;
depositing at the second surface of the magnetic field concentrator, the metal material by the cold thermal spraying to form a new reinforcement, over a predefined thickness corresponding at least to a sum of the entire thickness of the reinforcement removed and the predefined thickness of the layer of material removed;
tempering heat treatment of the magnetic field concentrator and the new reinforcement; and
finish-machining the new reinforcement such that the new reinforcement has a thickness equal to the sum of the entire thickness of the reinforcement removed and the predefined thickness of the layer of material removed.

18. The method of reconditioning the coil of claim 17, wherein, whenever the reinforcement of the coil is worn, further comprising a step of repeating:
removing the reinforcement over the entire thickness of the reinforcement;
removing the layer of material forming the magnetic field concentrator;
depositing the metal material by the cold thermal spraying until a subsequent new reinforcement is obtained, the subsequent new reinforcement having, after each reconditioning, a thickness corresponding to the thickness of a previous new reinforcement, increased by the thickness of the layer of material of the magnetic field concentrator removed.

19. The method of reconditioning the coil of claim 18, wherein the steps of removing the reinforcement over the entire thickness of the reinforcement, removing the layer of material forming the magnetic field concentrator, and depositing the metal material are repeated until a predefined maximum thickness of the reinforcement is reached.
